(19) United States
(12) Patent Application Publication
(10) Pub. No.: US 2006/0114246 A1
(43) Pub. Date: Jun. 1, 2006

(54) Maintaining a default window aspect ratio for each input of a display device

(76) Inventor: Bruce Young, LeMars, IA (US)

Correspondence Address: GATEWAY, INC.;ATTN: Patent Attorney, 610 GATEWAY DRIVE, MAIL DROP Y-04, N. SIOUX CITY, SD, 57049, US

(21) Appl. No.: 10/988,151

(22) Filed: Nov. 12, 2004

(51) Int. Cl. G09G 5/00

(52) U.S. Cl. 345/204

(57) ABSTRACT

The present invention is directed to a method and apparatus for storing an aspect ratio setting for each of multiple inputs of a display device, so that, when displaying content from each input, the aspect ratio setting of the display device is set to the value for the aspect ratio setting stored for that input. Furthermore, the aspect ratio setting for each input may be preset and may be changed by the user with the help of an on screen display.

### FIELD OF THE INVENTION

The present invention generally relates to the field of controlling viewing parameters of multimedia content.

### BACKGROUND OF THE INVENTION

Displays, such as televisions, movie screens, and computer monitors, each have a format that is typically defined as a ratio of the maximum horizontal width displayable to the maximum vertical height displayable. Similarly, video content, such as television shows and movies, also have a native format in which the content is most accurately displayed. For example, most content originally intended for display on a television has an aspect ratio or format of approximately 4:3, while most content originally intended for display on a movie screen has an aspect ratio or format of approximately 16:9. While there may be some variation from these two basic formats, by far these are the most predominant. Further, storage media, such as video cassettes and digital versatile discs (DVD) typically have their own native formats, but the associated players often have the ability to “play” media from more than one format. For example, DVDs may have content encoded in a 16:9 (“widescreen”) format or 4:3 format (or both formats), and a DVD player typically has the ability to play both of the formats on an associated display. The content on many DVDs is encoded in the 16:9 format, and thus the output from a DVD player is often in the 16:9 format. Conversely, the content on many video cassettes is recorded in the 4:3 format.

Often, the display device, such as a TV, has various display settings associated with each of the display formats. As the user switches between content on various inputs to the TV, the format of the content display can thus vary between different display formats. This switching between inputs on the TV can be frustrating to the viewer because the content from the connected input devices may be in different formats that require the user to change between appropriate display settings on the TV each time a switch between inputs is made. For example, if there are two inputs to the display device (such as a TV); one input may be connected to a DVD player and the other input may be connected to a VCR. As noted above, most content presented from the DVD player will be in 16:9 format while most content presented from the VCR will be 4:3 format. If the user is watching a movie playing on the VCR in the 4:3 format, and switches to watch a movie playing on the DVD player in the 16:9 format, then the user will need to also adjust the TV display settings from 4:3 to 16:9. In current TV technology, various settings have been made to track input selection, such as brightness and volume.

Therefore, it would be desirable to provide a system and method for remembering the preferred format for each input of a display system.

### SUMMARY OF THE INVENTION

Accordingly, the present invention is directed to a system and method for maintaining a default aspect ratio for each input of a display device.

In one aspect of the present invention, each input has an associated memory in which the aspect ratio for that input is stored. The value stored may represent any popular aspect ratio, for example, 4:3, 16:9, 16:10, stretch, center, panoramic and zoom. In another embodiment, the associated memory may be set to a predetermined value for each input, for example, 16:9 for a DVD input and 4:3 for a VCR input. Furthermore, in still another embodiment, a user interface may be presented to allow the user to adjust the aspect ratio for each input, perhaps using a remote control to manipulate values on an on-screen display (OSD).

In another aspect of the present invention, a television has at least two Audio/Video (AV) inputs, each providing content from a different source. Coupled to each input is a stored aspect ratio. When the television is configured to view content from one of such inputs, the associated stored aspect ratio is retrieved and the television is configured to display the content in the retrieved aspect ratio. In one embodiment of the present invention, the stored aspect ratios are stored in a persistent memory, perhaps battery-backed RAM, flash, FRAM, EEPROM, etc. In another embodiment of the present invention, the user can change the aspect ratio stored for each input using an input device such as a remote control while maneuvering through on-screen displays (OSDs).

In another aspect of the present invention, a display device has at least two Audio/Video (AV) inputs, each providing content from a different source. Associated with each input is a stored aspect ratio. When the display device is configured to view content from one of such inputs, the associated stored aspect ratio is retrieved and the display device is configured to display the content in the retrieved aspect ratio. The aspect ratio may include main picture stretch modes, such as: 16:9 (fill the 16:9 screen with the 16:9 content or make 4:3 content short and fat); center (put content into 4:3 window in the center of the display); panoramic (stretch 4:3 content to fill 16:9 display, but keep the center of picture correct while stretching the outside edges); and zoom (keep geometry of image correct but zoom 4:3 content so its width fills the display, possibly cutting off the top and/or bottom). In one embodiment of the present invention, the stored aspect ratios are stored in a persistent memory, perhaps battery-backed RAM, flash, FRAM, EEPROM, etc. In another embodiment of the present invention, the user can change the aspect ratio stored for each input using an input device such as a remote control while maneuvering through on-screen displays (OSDs).

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description serve to explain the principles of the invention.

### BRIEF DESCRIPTION OF THE DRAWINGS

The numerous advantages of the present invention may be better understood by those skilled in the art by reference to the accompanying figures in which:

FIG. 1 is a block diagram of an illustrative system implementing the present invention.

FIG. 2 is a flow chart of the present invention.

FIG. 3 is a flow chart of the present invention.

FIG. 4 is set of typical On Screen Display menus of the present invention.

### DETAILED DESCRIPTION OF THE INVENTION

Reference will now be made in detail to the presently preferred embodiments of the invention, examples of which are illustrated in the accompanying drawings.

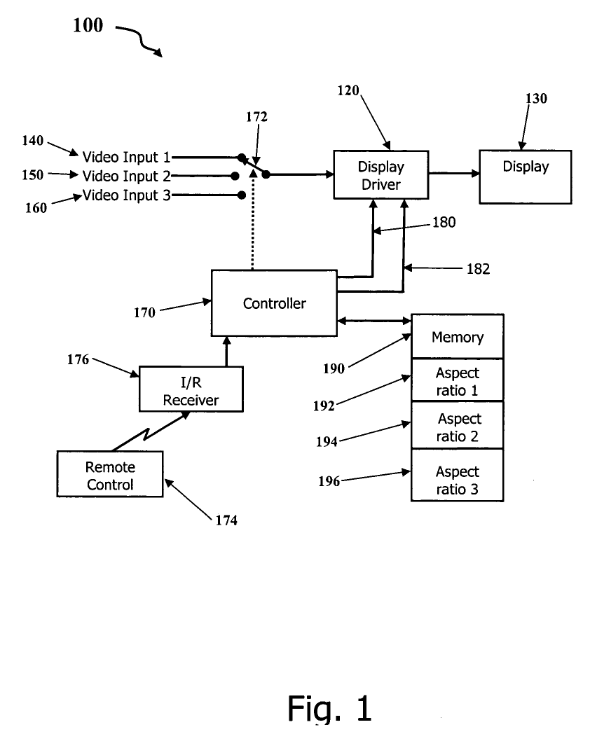

Referring generally now to FIG. 1, an illustrative display system according to the present invention is shown. This display system may be part a sub-system of a product, such as a television and other subsystems may be integrated, including possibly a power supply, tuner, audio subsystem, input jacks, front panel controls and indicators, etc. FIG. 1 shows the subsystems that may implement the present invention. Three video inputs are shown: Video Input 1 140, Video Input 2 150 and Video Input 3 160. Although three inputs are shown, the invention is useful on any system employing any number of inputs greater than one. Each video input is connected to an input of video switch 172. Video switch 172 may be any form of video switch known in the industry, including a mechanical switch with contacts, a relay, a video multiplexer integrated circuit, an arrangement of Field Effect Transistors (FETs), etc. In this embodiment, the input selection of video switch 172 is under the control of controller 170. Controller 170 may be any logic or processor or combination of the two known in the industry. Many examples of controllers already exist in the art of televisions and are currently used to control the operation of the television, perhaps changing channels in response to commands from a remote control, etc. Controller 170 is coupled to Infrared Receiver 176, so that it may receive commands from remote control 174. This is the same arrangement that may be currently used in television technology to receive commands such as channel-up, channel-down, volume-up, etc. Nothing special need be done nor any changes need be made to the current remote control art to implement this invention. Furthermore, some televisions have front panel controls and in another embodiment of the present invention, those front panel controls may be used in place of the remote control for controlling the aspect ratio settings.

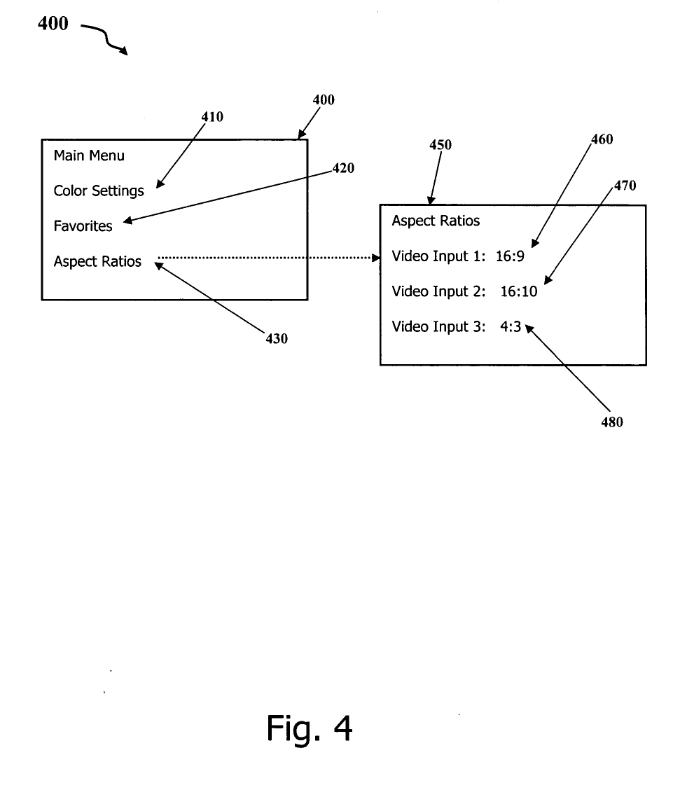

In general, a command may be received by the controller 170 from the remote control 174 through the Infrared Receiver 176 to enter a menu mode. The controller 170 then sends to the display driver 120 information to display on the display 130 in the form of an On-Screen Display (OSD) through the OSD signal path 182. The OSD may encompass the entire display, part of the display or may overlay the display, allowing the user to view content information in the background of the OSD. An example of an OSD is shown in FIG. 4. The controller 170 may present a first menu 400 through the OSD signal path 182 in response to receiving the menu command. The menu 400 may have selections for controlling various parameters of the system, including color settings 410, favorites 420, aspect ratios 430, etc. The user may maneuver to the aspect ratio selection 430 and then press a key on the remote to enter a second menu 450 for entering aspect ratios for each input. This menu may have a display line for each input showing the current aspect ratio setting of each input; in this example, video input 1 460, video input 2 470 and video input 3 480.

The controller 170 reads the memory 190, retrieves the values stored in each location associated with video input 1 192, video input 2 194 and video input 3 196, then displays the values in the appropriate fields of the menu 450 in the appropriate format. The memory 190 may be any form of persistent memory such as, battery-backed RAM, EEPROM, FLASH, FRAM, hard disk, floppy disk, optical disk, etc. Any of the video inputs may then be selected, perhaps by receiving a command from the remote to operate on that input. Each subsequent command might toggle the aspect ratio between all allowed values, perhaps 4:3, 16:9, 16:10, stretch, center, panoramic and zoom. As the aspect ratios are toggled, the values stored in the memory 190 may be updated to reflect the new value. As noted previously, the aspect ratio is generally a representation of a ratio between the horizontal width of the viewing area of a display and the vertical height of the viewing area of the display. For example, a 4:3 aspect ratio has a slightly greater width than height, so that, for example, a 4:3 display that is 16 inches wide would be 12 inches high. If the aspect ratio is 16:9, the display would be 16 inches wide and 9 inches high. The controller 170 tracks the aspect ratio values for each input and each time the aspect ratio changes for whichever input is currently selected by the video switch 172, the controller 170 instructs the display driver 120 to switch to the new aspect ratio through the aspect ratio control signal path 180. Each time the user changes the operative video input, perhaps using the remote control 174, the controller 170 retrieves the current aspect ratio of that input from the memory 190 and instructs the display driver 120 to switch to the aspect ratio of that video input through the aspect ratio control signal path 180.

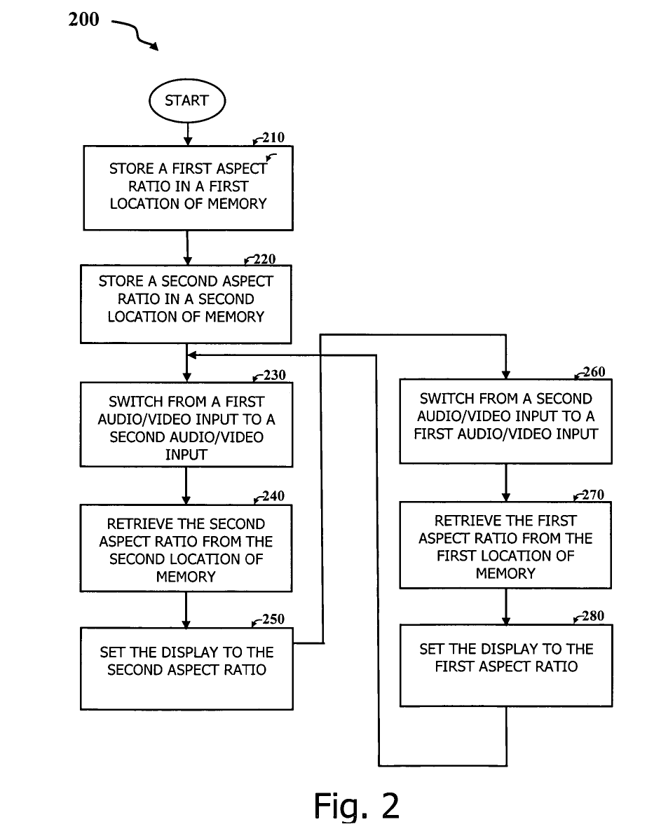

Referring to FIG. 2, which presents a flow chart of an illustrative process implementing the present invention, the step 210 includes storing a first aspect ratio in a first location of the memory 190. The step 220 includes storing a second aspect ratio in a second location of the memory 190. These aspect ratios may be the same or different and may be selected from a preset range of values. Steps 210 and 220 may be performed where the system is manufactured or may be performed by the user while the system is in use. Although shown as being performed only one time in FIG. 2, in other embodiments, the aspect ratios for each input may be modified by the user, perhaps through a user interface consisting of an On Screen Display (OSD) and a remote control.

Continuing with the step 230 of FIG. 2, a switch is made from viewing content from a first audio/video input to content from a second audio/video input. At the step 240, the value stored in the second location of the memory 190 is retrieved and in the step 250, the aspect ratio of the display is set to the value retrieved. At the step 260, a switch is made from viewing content from a second audio/video input to content from a first audio/video input. At the step 270, the value stored in the first location of the memory 190 is retrieved and in the step 280, the aspect ratio of the display is set to the value retrieved. Flow continues to iterate back to the step 230. The steps of switching may occur under user control, possibly when the user selects content from a different source. Each source may be labeled as, for example, “video-input-1” and “video-input-2”, respectively, or perhaps more specifically as “VCR” and “DVD”, respectively, or the like. In this embodiment, there are two audio/video inputs, but other embodiments may contain more than two audio/video inputs.

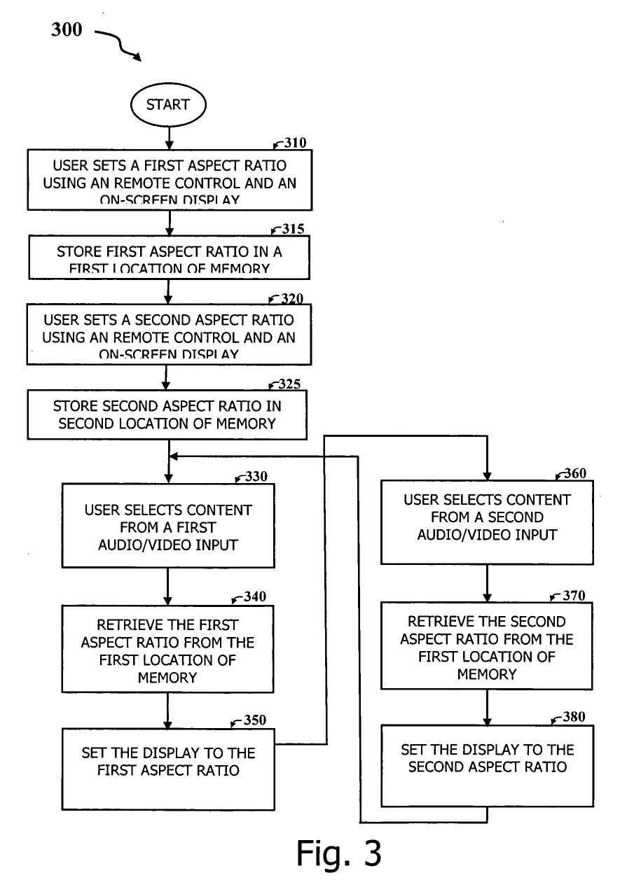

Referring to FIG. 3, a flow chart of the present invention, the step 310 includes the user selecting a first aspect ratio corresponding to a first audio/video input, perhaps using an OSD to make the selection. The step 315 includes storing the selected first aspect ratio in a first location of the memory 190. The step 320 includes the user selecting a second aspect ratio corresponding to a second audio/video input, perhaps using an OSD to make the selection. The step 320 includes storing the selected second aspect ratio in a second location of the memory 190. Although shown as being performed only one time in FIG. 3, in other embodiments, the aspect ratios for each input may be modified by the user, perhaps through a user interface comprising an On Screen Display (OSD) and a remote control.

Continuing with the step 330 of FIG. 3, a user selects viewing content from a first audio/video input. At the step 340, the value stored in the first location of the memory 190 is retrieved and in the step 350, the aspect ratio of the display is set to the value retrieved. At the step 360, a user selects viewing content from a second audio/video input. At the step 370, the value stored in the second location of the memory 190 is retrieved and in the step 380, the aspect ratio of the display is set to the value retrieved. Flow continues to iterate back to the step 330. The steps of selecting may occur under user control, possibly when the user selects content from a different source, perhaps each source is labeled as “video-input-1” and “video-input-2”, or more specifically “VCR” and “DVD”, or the like. In this embodiment, there are two audio/video inputs, but other embodiments may contain more than two audio/video inputs.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention oft he following claims to encompass and include such changes.

What is claimed is:

1. An apparatus for presenting visual content on a display comprising:
a display configured to present content with one of at least two aspect ratio settings;
a first input configured to receive a first input signal and a second input configured to receive a second input signal;
a switch circuit configured to connect one of said first input or said second input to said display; and
a memory configured to store a first aspect ratio setting for said first input and a second aspect ratio setting for said second input;
wherein a current aspect ratio setting of said display is set to said first aspect ratio setting when said display is connected by said switch circuit to said first input and the current aspect ratio setting of said display is set to said second aspect ratio setting when said display is connected by said switch circuit to said second input.

2. The apparatus for presenting visual content on a display of claim 1 wherein each of said at least two aspect ratio settings of said display are selected from a group comprising 4:3, 16:9, 16:10, stretch, center, panoramic and zoom.

3. The apparatus for presenting visual content on a display of claim 1 wherein said memory is a persistent memory.

4. The apparatus for presenting visual content on a display of claim 1 wherein said display is selected from a group consisting of a Cathode Ray Tube (CRT), a Liquid Crystal Display (LCD), a projection display and a plasma display.

5. The apparatus for presenting visual content on a display of claim 1 further comprising:
an on-screen display configured to present current values of said first aspect ratio setting and said second aspect ratio setting.

6. The apparatus for presenting visual content on a display of claim 5 further comprising:
an input device configured to modify said first aspect ratio setting and said second aspect ratio setting.

7. The apparatus for presenting visual content on a display of claim 6
wherein said input device is a remote control.

8. A method of presenting visual content on a display having at least a first input and a second input, the method comprising:
storing a first aspect ratio setting for a first input of the display in a first location in a memory;
storing a second aspect ratio setting for a second input of the display in a second location in said memory;
when switching from said first input to said second input, retrieving said second aspect ratio setting from said second location in said memory and setting the display to said second aspect ratio setting; and
when switching from said second input to said first input, retrieving said first aspect ratio setting from said first location in said memory and setting said display to said first aspect ratio setting.

9. The method of presenting visual content on a display of claim 8 wherein said first aspect ratio setting and said second aspect ratio setting is selected from a group comprising 4:3, 16:9, 16:10, stretch, center, panoramic and zoom.

10. A method of presenting visual content on a display of claim 8 additionally comprising maintaining said first aspect ratio setting and said second aspect ratio setting in said memory in a persistent manner.

11. A method of presenting visual content on a display of claim 8 wherein said display is selected from a group consisting of a Cathode Ray Tube (CRT), a Liquid Crystal Display (LCD), a projection display and a plasma display.

12. A method of presenting visual content on a display of claim 8 further comprising the steps of:
presenting an on-screen display including at least said first aspect ratio setting and said second aspect ratio setting.

13. A method of presenting visual content on a display of claim 12 further comprising the steps of:
receiving on an input device a new value for at least one of said first aspect ratio setting and said second aspect ratio setting.

14. A method of presenting visual content on a display of claim 13 wherein said input device is a remote control.

15. A television comprising:
a display, said display configured to present said television content in at least two aspect ratio settings;
a first input configured to receive a first input signal and a second input configured to receive a second input signal;
a switch circuit configured to connect one of said first input signal and said second input signal to said display; and
a memory configured to store a first aspect ratio setting corresponding to said first input signal and a second aspect ratio setting corresponding to said second input signal;
wherein a current aspect ratio setting of said display is set to said first aspect ratio setting when said display is connected by said switch to said first input and the current aspect ratio setting of said display is set to said second aspect ratio setting when said display is connected by said switch to said second input.

16. A television as claimed in claim 15 wherein each of said at least two aspect ratio settings is selected from a group comprising 43, 16:9, 16:10, stretch, center, panoramic and zoom.

17. A television as claimed in claim 15 wherein said memory is a persistent memory.

18. A television as claimed in claim 15 wherein said display is selected from a group consisting of a Cathode Ray Tube (CRT), a Liquid Crystal Display (LCD), a projection display and a plasma display.

19. A television as claimed in claim 15 further comprising:
an On-Screen Display configured to present the current values of said first aspect ratio setting and said second aspect ratio setting.

20. A television as claimed in claim 19 further comprising:
an input device configured to modify the current values of said first aspect ratio setting and said second aspect ratio setting.

21. A television as claimed in claim 20 wherein said input device is a remote control
